(19) United States
(12) Patent Application Publication
(10) Pub. No.: US 2009/0099309 A1
(43) Pub. Date: Apr. 16, 2009

(54) GUAYULE RESIN MULTIPOLYMER

(75) Inventor: RONALD W. GUMBS, East Brunswick, NJ (US)

Correspondence Address: HOLME ROBERTS & OWEN LLP, 16427 N. SCOTTSDALE RD., SUITE 300, SCOTTSDALE, AZ, 85254, US

(73) Assignee: Yulex Corporation

(21) Appl. No.: 11/873,013

(22) Filed: Oct. 16, 2007

(51) Int. Cl. C08L 93/04

(52) U.S. Cl. 525/54.45

(57) ABSTRACT

A method for preparing multipolymers of guayule resin with methacrylic, acrylic, vinyl and styrenic monomers and the resultant compositions are disclosed. As a result of the multipolymerization, the physical and chemical properties of the resin are improved. The primary advantage of multipolymerization over mixtures of resin with homopolymers is that it leads to a homogeneous material, the properties of which can be regulated by adjusting the ratio of the concentration of monomers in the feed. One attractive feature is the production of low viscosity resins with reactive groups that can compete directly with oligomers and macro-monomers used in solventless inks, coatings and adhesives. The low cost of the resin, a byproduct from the extraction of hypoallergenic rubber from guayule and other plants bearing rubber or rubber-like hydrocarbons provides for hybrid low molecular weight copolymers that are cost competitive with state-of-the-art oligomers.

### FIELD OF THE INVENTION

The present invention relates generally to resins derived from plant species bearing rubber and rubber-like hydrocarbons and, more specifically, to the preparation and utilization of multi-component copolymers of guayule resin with improved physical and chemical properties.

### BACKGROUND OF THE INVENTION

A large number of plant species bearing rubber and rubber-like hydrocarbons can be used as sources of guayule resins and guayule-like or guayule-type resins. Included among these plant materials are guayule (Parthenium argentatum Gray), gopher plant (Euphorbia lathyris), mariolla (Parthenium incanuum), rabbit brush (Chrysothamn nauseosus), candlilla (Pedilanthus macrocarpus), Madagascar rubbervine (Cryptostegia grandiflora) milkweeds (Asclepsias syriaca, speciosa, subulata, et al.), goldenrods (Solidago altissima, graminifolia, rigida, et al.), pale Indian plantain (Cascalia atriplicifolia), Russian dandelion (Taraxacum kok-saghyz), mountain mint (Pycnanthemum incanum), American germander (Teucreum canadense) and tall bellflower (Campanula americana). Hence, it is recognized that whenever reference is made to guayule plants or shrubs, it is to be understood that the above-described plants and shrubs can also be utilized in the present disclosure.

Natural rubber is a biopolymer of cis-1,4-polyisoprene with 400-50,000 isoprene units enzymatically linked in a head-to-tail configuration. It is formed by a branch of the isoprenoid pathway which also leads to the production of dimers, trimers, tetramers, and so forth. These lower molecular weight molecules and various isomers constitute the resin.

### BRIEF DESCRIPTION OF THE FIGURES

FIG. 1 is a GC/MS chromatogram of guayule monoterpenes.

FIG. 2 illustrates the relative average molecular weights of guayule resin/isooctyl acrylate copolymer.

FIG. 3 is a graph depicting a first heat scan of guayule resin/isooctyl acrylate copolymer.

FIG. 4 is a graph depicting a re-heat scan of guayule resin/isooctyl acrylate copolymer.

### DETAILED DESCRIPTION

The present invention relates generally to resins derived from plant species bearing rubber and rubber-like hydrocarbons and, more specifically, to the preparation and utilization of multi-component copolymers of guayule resin with improved physical and chemical properties. It entails multi-component copolymerization which is defined as a process wherein many monomers are incorporated as integral segments of a polymer. This process is used to produce products with properties that are different from those of homopolymers or mixtures thereof. In general, multipolymers possess physical and chemical properties intermediate between different homopolymers. The magnitude of the numerical value of these properties generally depends on the concentration of monomer units incorporated in the multipolymer.

Guayule resin adds to the double bonds of conventional monomers to form multipolymers which combine the properties of the homopolymers and guayule resin. This is significant because it can therefore react with unsaturated polyester resins and epoxy acrylates to produce solventless polyester and vinyl ester resins, which typically use styrene monomer as the reactive diluent. The resin, which is a mixture of diverse materials and low molecular weight cis-1,4-poly isoprene (DP less than 400) is a green viscous oil, which dries to form a tacky material.

Thus, disclosed herein is a method for preparing these multipolymers. It entails treating the resin as a monomer in a polymerization process using vinyl, styrenic, and esters of acrylic and methacrylic acids as comonomers. The process is initiated by the thermal decomposition of an initiator to form free radicals, leading to radical polymerization. The polymerization can also be initiated using reduction oxidation (redox) systems, heat or radiation.

As a result of the multipolymerization, the physical and chemical properties of the resin are improved. The primary advantage of multipolymerization over mixtures of resin with homopolymers is that it leads to a homogeneous material, the properties of which can be regulated by adjusting the ratio of the concentration of monomers in the feed. One attractive feature is the production of low viscosity resins with reactive groups that can compete directly with oligomers and macro-monomers used in solventless inks, coatings and adhesives. The low cost of the resin, a byproduct from the extraction of hypoallergenic rubber from guayule and other plants bearing rubber or rubber-like hydrocarbons provides for hybrid low-molecular-weight copolymers that are cost competitive with state-of-the-art oligomers.

Sources of Resin

Guayule and other rubber producing plants are adhesive factories because they elaborate natural rubber, resins, terpenoids and oleic acid triglycerides. Guayule, with its higher concentration of resin and lower concentration of proteins, is a superior and more efficient adhesive plant. This conclusion is based on the physical and chemical nature of both the resin and rubber.

An excellent tackifier in radiation-curable and natural rubber adhesives, the resin possesses strong adhesion to numerous surfaces from bare concrete to Teflon® and the remarkable property of bonding underwater. Upon exposure to a high intensity UV lamp (80 W cm⁻¹), it cures within a second without the need for a photo-initiator. The low viscosity of solutions in nonvolatile acrylates suggests its application in UV curable printing inks, and there is the large market for radiation curable coatings, which can be tailored through multipolymerization.

Impregnated into wood, whole resin provides anti-termitic and wood-rot resistance, and protection against other organisms, such as marine borers, that destroy wood. There is speculation that the resin might protect wood and trees against insects, such as the carpenter ant and bark beetle. Guayule resin protects wood against termite, molluscan borer, and fungal attacks in a persistent manner, an important feature of a wood preservative. Composites made from combinations of wood, plastic and guayule bagasse or resin yield termite and fungus-resistant products as taught by Nakayama. Products include lumber, plywood, poles, railroad crossties, etc., which exhibit resistance to termite infestation and resistance to fungal decay. The component(s) of guayule resin responsible for this phenomenon are terpenoids. Incorporation of guayule resin with existing wood coatings or adhesives may provide both insect control and modified adhesive properties.

Despite its aggressive adhesion to all manner of surfaces as alluded to previously, guayule resin has been suggested as an adhesive modifier of amine-cured epoxy resin for making strippable coatings with good impact resistance and hardness. The degree of strippability can be controlled by the amount of resin used in the formulation, of course. Peelable coatings are important in temporary protection of commercial and military structures and vehicles, and epoxy-amine polymers can be formulated as low VOC coatings with excellent chemical resistance, water resistance, and corrosion resistance. It was suggested that acid-base adhesive interactions are responsible for the loss of adhesion and resulting strippability.

Because of the presence of Guayulin A, guayule resin-modified marine coatings inhibit surface fouling by barnacles and seagrass Isolated resin fractions (solvent extraction) exhibit varying toxicity to shrimp and/or barnacles, suggesting the natural products responsible for antifouling can be concentrated in controlled-release paints or plastics. Antifouling paints are important to the economic interests of US military and industry; tri-butyl tin and copper sulfate formulations, used traditionally, are under significant environmental and price pressures, respectively.

The concentration of resin in the wood and leaf is shown in Table 1. Because the leaves (15-20% of the plant) are not included in the biomass used to extract the latex, they are essentially discarded. Yet, the extracted resin may eventually prove to be a useful comonomer for the development of a variety of biobased materials because it contains several monoterpenes, including α-pinene (16.7%), β-pinene (13.5%), camphene (1.2%), sabinene (6.5%), β-myrcene (2.5%), limonene (5.9%), terpinolene (9.2%), and β-ocimene (2.1%). What is more, the concentration of sesquiterpene compounds in the essential oil of the leaf is 39.5%.

TABLE 1
Composition of Guayule Leaves and Wood

| Component | Leaf, % | Wood, % |
|---|---|---|
| Rubber | 0.3 | 6.7 |
| Wood Resin (Acetone Extract) | | 7.4 |
| Hexane-soluble fraction | | 4.4 |
| Leaf Resin (Methylene Chloride Extract) | 7.8 (?) | |
| Was | 0.3 | 0.06 |
| Residual Matter | 92.0 | 83.0 |
| Moisture | 8.9 | 2.4 |
| Protein (N × 6.25) | 14.0 (?) | 13.9 |
| Acid detergent fiber | 18.0 | 51.6 |
| Crude fiber | 10.7 | 42.6 |
| Lignin | 4.0 | 17.2 |
| Ash, mineral matter | 19.9 (?) | 4.1 |
| Petroleum ether extractable | 0.2 | 0.2 |
| Total sugars | 3.8 | 1.4 |
| Inulins | 0.2 | 0.2 |
| Betaine | 2.0 | 1.0 |

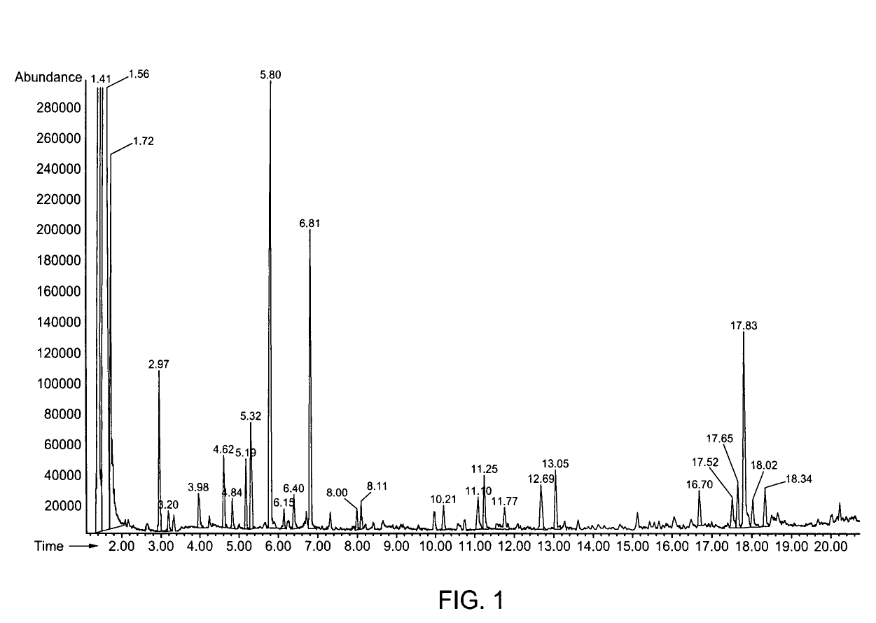

The resin (acetone-extract) consists of two fractions: a non-volatile fraction and a volatile fraction. Guayule bagasse typically contains 10% water soluble material: protein, carbohydrates (levulin, inulin, and other polysaccharides), and inorganics. When bagasse was extracted with acetone and the solution concentrated to 10% solids, the gas chromatogram shown in FIG. 1 illustrates that a large number of peaks and the resulting mass spectra showed the extracted compounds, which are given in Table 2 below.

TABLE 2
Possible Volatile Compounds Present in the Acetone-Extract of
Guayule Bagasse.

| | Time, average |
|---|---|
| | of, |
| Compound | Minutes |
| Santolina triene | 5.165-5.219 |
| α-Pinene | 5.767-5.834 |
| D-Verbenone | 13.007-13.092 |
| 1-R-, α-pinene | 5.767-5.834 |
| Camphene | 6.121-6.169 |
| β-Pinene | 6.772-6.857 |
| Bicyclo [3.1.1] heptane, 6,6-dimethyl-2-methylene-, (1S)- | 6.772-6.857 |
| Limonene | 8.069-8.135 |
| D-Limonene | 8.069-8.135 |
| Cyclopentane, 1-methylene-3(1-methylethylidene)- | 12.648-12.727 |
| Bicyclo [3.1.1] hept-3-en-2-one, 4,6,6-trimethyl-, (1S)- | 13.007-13.092 |
| Bicyclo [3.1.1] hept-3-en-2-one, 4,6,6-trimethyl- | 13.007-13.092 |
| Copaene | 17.476-17.543 |
| Germacrene D | 17.476-17.543 |
| A-Cubebene | 17.476-17.543 |
| 6s-2,3,8,8-Tetratamethyltricyclo [5.2.2.0 (1,6) undec-2-ene | 17.610-17.677 |
| Vanillin | 17.988-18.055 |
| Bicylo [5.3.0] decane, 2-methylene-5-(1-methylvinyl)-8-methyl- | 18.304-18.359 |
| 1,4-Methano-1H-indene, octahydro-4-methyl-8-methylene-7- | 18.304-18.359 |
| (1-methylethyl)-, [1S-(1. α,3a. beta., 4. α, 7. α, 7a. beta.)]- | |
| Spatulenol | 22.433-22.518 |
| 1H-Cycloprop[e]azulen-7-ol,decahydro-1,1,7-trimethyl-4-methylene-, | 22.433-22.518 |
| [1a.α.,7. beta., 7a. beta., 7b. α)]1- | |
| (—)-Spathulenol | 22.433-22.518 |
| 2-Naphthalenemethanol, 1,2,3,4,4a,5,6,7-octahydro- | 23.657-23.748 |
| α., α., 4a,-tetramethyl-, (2R-cis)- | |
| 2-Naphthalenemethanol, decahydro-, α., α., 4a-trimethyl-8-methylene-, | 24.101-24.168 |
| [2R-(2. α., 4a. α., 8a.beta.)]- | |

These compounds are relevant because they are extracted with acetone and are included in the gum. The gum is the nonvolatile fraction, which includes low molecular weight (LMW) rubber (ca. 20%). This fraction of cis-1,4-poly(isoprene) chains precipitates out with the addition of 90% ethyl alcohol to the acetone extract. Its concentration depends on the age of the plant, higher in younger plants. The presence of LMW rubber is the primary reason for the stickiness of the resin.

Extraction of Resin

Guayule plants are pulverized by a hammer mill and the rubber is first isolated according to methods known in the art. Guayule-like resins are typically extracted from these plants, or from resinous rubber obtained from such plants, with an organic polar solvent. These solvents include alcohols, esters and ketones; for example, acetone. Supercritical fluid (SCF) extraction methods may also be used.

Examples of the concentration of each compound in the resin are shown in Table 3 and the composition of the organic acids after saponification of the organic extracts of are shown Table 4.

TABLE 3
Organic Extract - Non-Rubber Isoprenoids and Trigylcerides from
Various Cultivars.

| | Cultivar # | | | | | |
|---|---|---|---|---|---|---|
| Component, wt. % | 593 | 11634 | N575 | N576 | 11635 | 12229 |
| Terpenes, | 1 | 2 | 1 | 1 | 2 | 1 |
| sesquiterpenes | | | | | | |
| Guayulin A | 9 | 9 | 10 | 10 | 10 | 8 |
| Guayulin B | 2 | 2 | 2 | 1 | 3 | 1 |
| Sesquiterpene | 3 | 1 | 1 | 1 | 1 | 1 |
| cinnamate C | | | | | | |
| Sesquiterpene | 1 | <0.5 | <0.5 | <0.5 | <0.5 | <0.5 |
| anisate D | | | | | | |
| Argentatin A | 8 | 15 | 17 | 12 | 14 | 12 |
| Argentatin B | 4 | 6 | 7 | 4 | 6 | 5 |
| Argentatin C | 1 | | | | | |
| Triterpenoid D | 3 | 4 | 5 | 4 | 5 | 4 |
| Sterol glycosides | 2 | | | | | |
| Other phytosterols, | 9 | | | | | |
| triterpenoids | | | | | | |
| Fatty acid triglycerides | 13 | 19 | 7 | 18 | 7 | 13 |
| TOTAL | 56 | 58 | 50 | 51 | 48 | 45 |

TABLE 4
Composition of Cultivar 593 Organic Acids (w/w %) after
Saponification.

| Acid | Batch #1 | Batch #2 |
|---|---|---|
| cinnamic | 25 | 16 |
| p-anisic | 3 | 7 |
| palmitic | 15 | 10 |
| stearic | 2 | 1 |
| oleic | 5 | 4 |
| linoleic | 36 | 44 |
| linolenic | 12 | 18 |

Guayule resin is a tacky gum which becomes a free-flowing liquid at temperatures above about 50° C. Because it cures or polymerizes oxidatively to form a brittle and friable solid, its physical and chemical properties must be improved. One approach to achieving this goal is multipolymerization. As described in this disclosure, resin copolymerizes with acrylic, styrenic and vinyl monomers in toluene, and the multipolymers possess unique physical and chemical properties. This is significant because the resin is incompatible with acrylic and other polymers used in attempts to increase cohesive strength. In fact, it is compatible only with poly(terpenes) and poly(isoprene).

The whole resin copolymerizes with many monomers. Of the organic acid components, oleic, linoleic, linolenic and cinnamic acid fractions are reactive sites for copolymerization. Other compounds with a double bond can be considered comonomers. For instance, parthenyl cinnamate, the cinnamic acid ester of partheniol, is copolymerizable; cinnamic acid is essentially styrene with a carboxylic acid group in the β-position.

Multipolymerization occurs readily in refluxing toluene with or without benzoyl peroxide (7% of synthetic monomer) or α,α′-azodiisobutyronitrile (10%) in two hours with stirring. The products are isolated after evaporation of the solvent. The 1:1 copolymer with styrene is insoluble in methanol, ethanol and isopropyl alcohol. Similarly, the product from the reaction of two parts resin and one part styrene is insoluble in these solvents, which are good solvents for the resin.

The low molecular weight average of the multipolymers prepared in toluene is attributed to chain transfer to solvent. A chain transfer reaction is one in which the free radical center is transferred from a growing chain to another molecule (e.g., solvent or monomer). The growth of the chain previously bearing the free radical would thereby be terminated, and the molecule acquiring the radical should be capable of starting a new chain, which would grow at the same rate. A prominent mechanism for chain transfer reactions of this nature consists in removal by the chain radical of a hydrogen atom from the molecule which intervenes, i.e., the transfer agent as shown in Table 5.

TABLE 5
Transfer Constants for Various Substances with Styrene

Transfer constants
Cs × 10⁴

| Transfer agent | 60° C. | 100° C. |
|---|---|---|
| Cyclohexane | 0.024 | 0.16 |
| Benzene | 0.018 | 0.184 |
| Toluene | 0.125 | 0.65 |
| Ethylbenzene | 0.67 | 1.62 |
| Carbon tetrabromide | 13,600 | 23,500 |

The reactivity of resin with synthetic monomers represents a major breakthrough toward the development of radiation-curable coatings, inks and coatings for numerous reasons. First, it is now possible to incorporate reactive groups to permit chemical adhesion to specific substrates. Primary adhesion to substrates with pendant hydroxyl groups can be achieved with the incorporation of isocyanate groups on the resin by copolymerization with 2-hydroxyl ethyl acrylate and subsequent reaction with a diisocyanate. In fact, there are hydroxyl groups on various compounds in the resin that are capable of reaction with the diisocyanate. Primary bonding to surface hydroxyl groups on Mylar® treated with a corona discharge is possible. In addition, comonomers with acidic groups enhance adhesion to metal. What is more, epoxy groups can be incorporated by including glycidyl methacrylate in the feed.

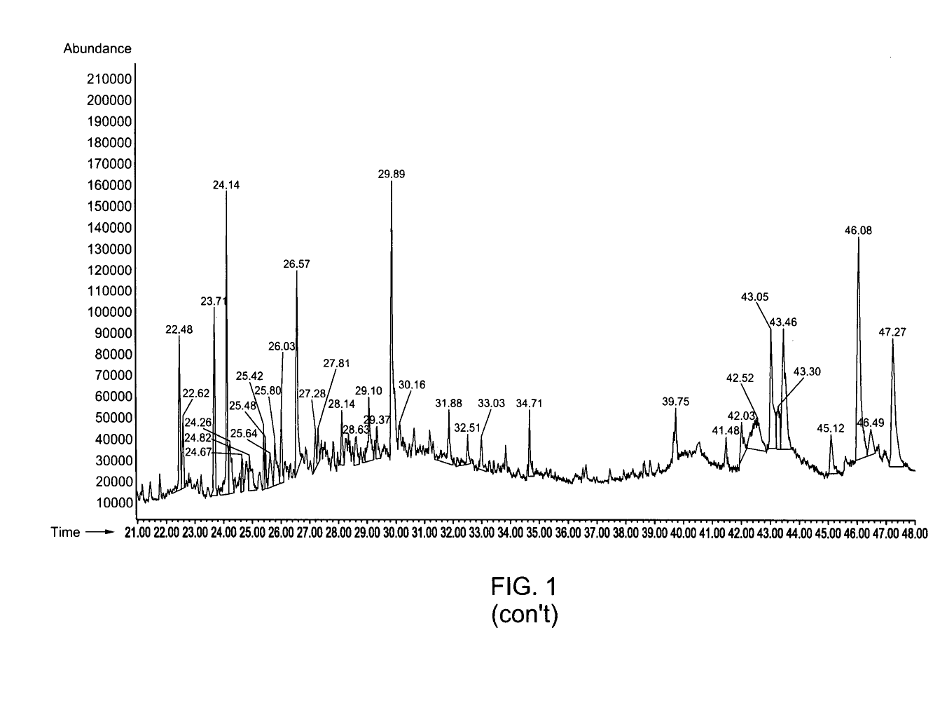

Second, copolymerization increases the molecular weight average of the bulk resin and therefore its cohesive strength. For example, see FIG. 2 illustrating the relative average molecular weight of a resin/isooctylacrylate. Mechanical properties such as tensile strength are affected by molecular weight. Third, low-molecular-weight compounds are chemically incorporated into the product and will not migrate or leach out after application of the end product. Fourth, copolymerization improves the optical clarity of the resin. Finally, copolymerization increases the thermal and oxidative stability of the resin, dramatically leading to application by hot melt processes.

Also according to the present disclosure, novel materials are prepared in a bulk or solution multipolymerization process which combines the reactive groups of the resin with the double bonds of the synthetic monomer. The result is an increase in the average molecular weight and forms hard, tough polymeric materials that can be tailored for diverse applications, including coatings, printing inks, and adhesives. Thus, the compositions of the present disclosure have the potential to replace many of the oligomers in adhesives, coatings and inks because of lower cost and better performance.

The present disclosure is further illustrated by the following examples that are not intended to limit its scope. In the examples, all parts, ratios and percentages are by weight unless otherwise indicated. Table 6 illustrates the chemical composition of the resins used in the below examples. The percent nitrogen×6.3 is an estimate of the amount of protein in the sample. The Iodine number gives the degree of unsaturation in the sample. The Hydroxyl Value is the concentration of hydroxyl groups present; and the saponification value is the concentration of triglycerides and other esters present.

TABLE 6
Chemical Analysis of Guayule resin used in Examples

| Analysis | Result | Duplicate | Mean |
|---|---|---|---|
| Carbon | 75.25% | 75.26% | 75.25% |
| Hydrogen | 10.73% | 10.48% | 10.61 |
| Nitrogen | <0.5% | <0.5% | |
| Iodine Value/ | 53.54 | 53.55 | 53.54 |
| Number | | | |
| Hydroxyl | 43 mg KOH/g | 43 mg KOH/g | 43 mg KOH/g |
| Value | | | |
| Saponification | 77.3 mg KOH/g | 78.1 mg KOH/g | 77.7 mg KOH/g |
| Value | | | |

### EXAMPLE 1

To a 1-liter four-necked resin kettle equipped with a mechanical stirrer, nitrogen inlet, thermometer, reflux condenser and addition funnels were added the ingredients shown in Table 7 below.

TABLE 7
Composition of feed in the preparation of multipolymer.

| Ingredient | Parts |
|---|---|
| Guayule Resin | 10.5 |
| Ethyl Acrylate | 4.8 |
| Isobutyl Vinyl Ether | 3.6 |
| Styrene | 1.7 |
| Maleic Anhydride | 0.6 |
| Azo bis isobutyronitrile | 1.0 |
| Toluene | 200 |

The mixture was allowed to reflux until its percent solids remained constant and the product was isolated after evaporation of toluene. The percent conversion was 99% based on percent solids of the solution after refluxing and thin films of the product are optically transparent, indicating a compatible mixture.

### EXAMPLE 2

A 1:1 mixture of styrene and resin, by weight, was added to a mixture of toluene containing benzoyl peroxide at concentration of 10% of styrene monomer. The solution was refluxed for two hours with stirring and the product was isolated after evaporation of toluene. The percent conversion was 99% based on percent solids of the solution after refluxing. Thin films of the product are optically transparent, indicating a compatible mixture.

### EXAMPLE 3

A 1:1 mixture of methyl methacrylate and resin, by weight, was added to a mixture of toluene containing azo bis isobutyronitrile at concentration of 10% of methyl methacrylate. The solution was refluxed for two hours with stirring and the product was isolated after evaporation of toluene. The percent conversion was 99% based on percent solids of the solution after refluxing. Thin films of the product are optically transparent, indicating a compatible mixture.

### EXAMPLE 4

A 1:1 mixture of isooctyl acrylate and resin, by weight, was added to a mixture of toluene containing azo bis isobutyronitrile at concentration of 2% of acrylate. The solution was refluxed for two hours with stirring and the product was isolated after evaporation of toluene. The percent conversion was 90% based on percent solids of the solution after refluxing. Thin films of the product are optically transparent, indicating a compatible mixture.

Differential Scanning Calorimetry (DSC)

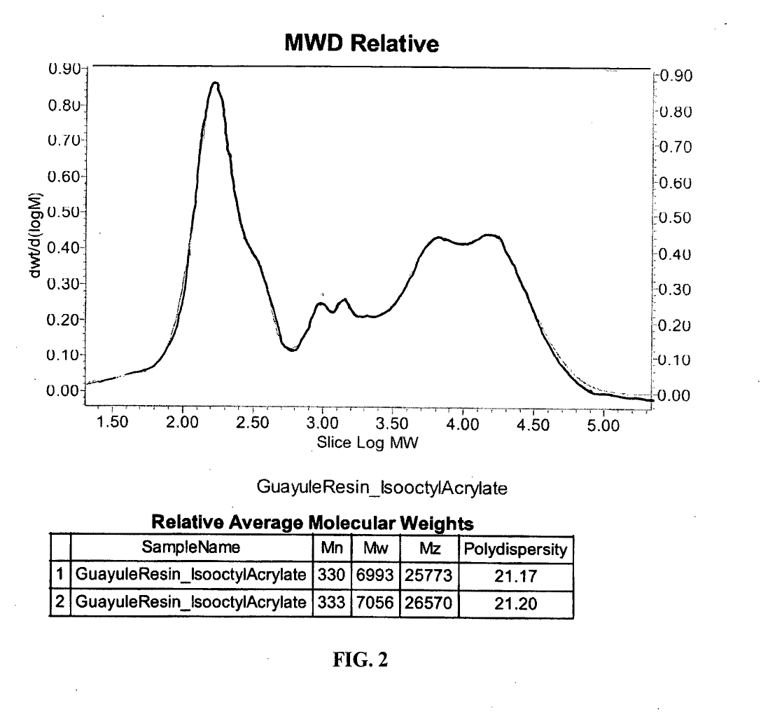

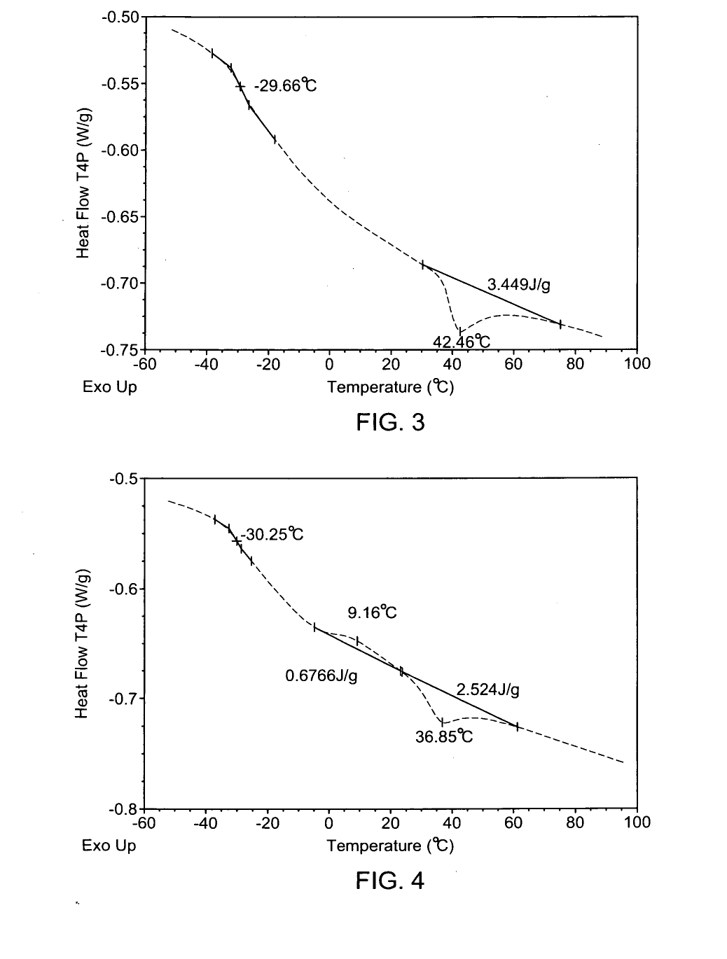

DSC analysis of a small sample indicates the thermal properties of the copolymer. The DSC scan is shown in FIGS. 3 and 4 as the heat and reheat curves. The glass transition temperature, Tg, appears to be approximately −30 C, and the melt appears at 36-42 C. This is significant because it indicates that multipolymerization can lead to application by hot melt processes; neat resin is thermally unstable. In addition, the optical clarity of the sample demonstrates improved stability and more transparent binders for application in UV and visible curing processes.

### EXAMPLE 5

A 1:1 mixture of ethyl methacrylate and resin, by weight, was added to toluene and the solution was refluxed for two hours with stirring. The percent conversion after two hours was 72%, which increased to 90% after four hours of reflux. This experiment is significant because of the absence of a free radical initiator.

### EXAMPLE 6

A 1:1 mixture of styrene and resin, by weight, was added to toluene and refluxed for two hours with stirring. The conversion after two hours was 68% and 83% after four hours. Thin films of the product are optically transparent, indicating a compatible mixture. The GPC results of solutions of the resin and three multipolymers in THF are shown below in Table 8.

TABLE 8
GPC Data on Multipolymers

| Exp. # | Mn | Mw | Mz | Poly-dispersity |
|---|---|---|---|---|
| Guayule Resin | 485 | 1,316 | 11,223 | 2.7 |
| Example 1 | 763 | 13,780 | 157,866 | 18.5 |
| Example 2 | 590 | 3,469 | 10,950 | 5.9 |
| Example 3 | 315 | 2,456 | 8,178 | 7.8 |
| Example 4 | 332 | 7,025 | 26,172 | 21.2 |

Where Mw is the weight average molecular weight; Mn is the number average molecular weight; Mz is the molecular weight average that would be obtained from sedimentation. The sample was prepared and injected on the Water GPCV2000-triple detector instrument. Data processing was done with Waters' Empower® software using a relative calibration method (against polystyrene standards) and with a Universal calibration method to provide molecular weight, intrinsic viscosity, and branching information. Acrylates are used in coatings, inks and adhesives because their glass transition temperature (Tg), shown in Table 9, can be varied to yield the most desirable viscoelastic properties for the specific applications. The primary benefits are tailorability, versatility, reactivity, flexibility and compatibility.

TABLE 9
Glass Transition Temperature versus Application Area

| Tg (° C.) | Suggested application area |
|---|---|
| 35-50 | General industrial coatings |
| 10-40 | Decorative paints |
| 25-35 | Binders for inks |
| −60-25 | Adhesives |

The Tg of a polymer is the simple average value representing a range of temperatures through which the polymer changes from a hard and often brittle material into one with soft, rubber-like properties. By selecting the proper monomers, Tg of the polymer and therefore the likely application area can be varied. The Tgs of homopolymers of MMA, MA and EA are 106, 6 and −24° C., respectively.

The versatile nature of the disclosed method and compositions suggest that additional polar monomers used in acrylic pressure-sensitive adhesives can be utilized. Acrylic acid, derivatives of acrylamide and monomers with pendant isocyanate groups can also be employed. The inclusion of hydroxyl ethyl acrylate or methacrylate in the co-monomer feed is an obvious method to incorporate hydroxyl groups, and these also react with diisocyanates or unsaturated isocyanate, e.g., α,α-dimethyl meta-isopropenyl benzyl isocyanate to produce isocyanate and vinyl functionality in the multipolymer. Similarly, maleic anhydride units in the multipolymer are reactive sites for compounds with hydroxyl and amine groups.

The ability of guayule resin to copolymerize with unsaturated monomers to form thermoplastic multipolymers with low viscosities opens up many new product opportunities. One advantage of the presently disclosed method is the ability to make a unique family of copolymers having a pre-selected functionality (acrylic, methacrylic, maleic half ester, styrene, vinyl ether, isoprene, epoxy, pinene) that is capable of subsequent in situ copolymerization to produce numerous products with minimal shrinkage. The combination of low shrinkage and low viscosity which permits less expansion in the conversion from liquid monomer to solid polymer is the most attractive feature that demonstrates superior performance above that of the competition. Development of corrosion-resistant coatings may be possible as a result of the superior adhesion.

All 100% solids systems using state-of-the-art technology are based on reactive diluents to produce viscosities of the same order of magnitude as those of conventional solvent based formulations. Evaporation of the solvent and polymerization of the reactive diluents involve shrinkage. The concentration of reactive diluent monomer in the guayule multipolymer coatings and adhesives is advantageously low and therefore the expansion of volume on drying is low.

Another advantage of multipolymerization is based on the fact that the resin is compatible or miscible only with polyisoprene and the polyterpenes. This is in contrast to conventional blending of guayule resin with acrylic and other polymers typically results in opaque products which separate into macro instead of micro phase domains.

Various embodiments of the invention are described above in the Detailed Description. While these descriptions directly describe the above embodiments, it is understood that those skilled in the art may conceive modifications and/or variations to the specific embodiments shown and described herein. Any such modifications or variations that fall within the purview of this description are intended to be included therein as well. Unless specifically noted, it is the intention of the inventors that the words and phrases in the specification and claims be given the ordinary and accustomed meanings to those of ordinary skill in the applicable art(s).

The foregoing description of a preferred embodiment and best mode of the invention known to the applicant at this time of filing the application has been presented and is intended for the purposes of illustration and description. It is not intended to be exhaustive nor limit the invention to the precise form disclosed and many modifications and variations are possible in the light of the above teachings. The embodiment was chosen and described in order to best explain the principles of the invention and its practical application and to enable others skilled in the art to best utilize the invention in various embodiments and with various modifications as are suited to the particular use contemplated. Therefore, it is intended that the invention not be limited to the particular embodiments disclosed for carrying out the invention.

What is claimed is:

1. A method for making a resin multipolymer, comprising:
reacting a resin with an unsaturated monomer, wherein the reaction forms a thermoplastic multipolymer.

2. The method of claim 1, wherein the resin in present in amount in the approximate range of twenty-five to seventy-five percent by weight.

3. The method of claim 1, wherein the unsaturated monomer is a synthetic monomer.

4. The method of claim 1, further including rubber in the reaction.

5. The method of claim 1, wherein the unsaturated monomer is selected from a group consisting of: isoctyl acrylate, styrene, parthenyl cinnamate, acrylic, methacrylic, maleic half ester, vinyl ether, isoprene, acrylic acid, acrylamide, ethyl methacrylate, methyl methacrylate, epoxy, epoxy acrylate, and pinene.

6. The method of claim 1, further including using an organic solvent in the reaction.

7. The method of claim 1, further including using a free radical inhibitor in the reaction.

8. The method of claim 7, wherein the free radical inhibitor is selected from the group consisting of: benzoyl peroxide and azo bis isobutyronitrile.

9. The method of claim 1, further including using a catalyst in the reaction having the general formula: 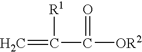
wherein R¹ is H or CH₃ and R² is a linear hydrocarbon group of about 2 to about 14 carbon atoms.

10. The method of claim 1, further including initiating the reaction by thermal decomposition of an initiator to for form free radicals.

11. The method of claim 10, wherein the free radicals promote radical polymerization.

12. The method of claim 1, further including initiating the reaction by a method selected from the group consisting of: reduction oxidation; heat; and radiation.

13. The method of claim 1, further including reacting the resin and unsaturated monomer with a comonomer.

14. The method of claim 13, wherein the comonomer is an unsaturated polyester.

15. A multicomponent copolymer comprising:
a resin and one or more reaction products, wherein the reaction product is produced by reacting the resin with an unsaturated monomer.

16. The multicomponent copolymer of claim 15, further including rubber.

17. The multicomponent copolymer of claim 15, wherein the copolymer is a component of a product selected from a group consisting of: coatings, inks and adhesives.

18. A process for manufacturing a multicomponent copolymer comprising:
adding an unsaturated monomer to a resin and an initiator at a temperature suitable for decomposition of the initiator, wherein the unsaturated monomer reacts with the resin forming the copolymer.

19. The process of claim 18, wherein the initiator is a free radical initiator.

20. The process of claim 18, further including using supercritical reaction medium.

21. The process of claim 18, further including extracting the resin from a plant species bearing rubber or rubber-like hydrocarbons.

22. The process of claim 21, wherein the plant species is Parthenium argentatum.
